(19) United States
(12) Patent Application Publication
(10) Pub. No.: US 2026/0158763 A1
(43) Pub. Date: Jun. 11, 2026

(54) GLASS ARTICLE CONFIGURED TO ACCOMMODATE THERMAL DIMENSIONAL CHANGES OF MIDFRAME THAT JOINS GLASS SUBSTRATE TO FRAME

(71) Applicant: CORNING INCORPORATED, CORNING, NY (US)

(72) Inventors: Rohan Ram Galgalikar, Redmond, WA (US); Khaled Layouni, Fontainebleau (FR); Christopher Lee Timmons, Big Flats, NY (US); Paul James Yanisko, Barto, PA (US)

(21) Appl. No.: 18/707,024

(22) PCT Filed: Oct. 28, 2022
(86) PCT No.: PCT/US2022/048135

§ 371 Date: May 2, 2024

Related U.S. Application Data
(60) Provisional application No. 63/275,738, filed on Nov. 4, 2021.

(51) Int. Cl. B32B 7/05; B32B 3/12; B32B 5/18; B32B 17/06; B32B 17/10

(52) U.S. Cl. CPC B32B 7/05; B32B 3/12; B32B 5/18; B32B 17/066; B32B 17/10; B32B 2305/022; B32B 2305/024; B32B 2307/308; B32B 2605/003

(57) ABSTRACT

Disclosed are embodiments of a glass article including a glass substrate, a midframe, and a frame. The glass substrate has a first major surface and a second major surface in which the second major surface is opposite to the first major surface. The midframe is attached to the second major surface of the glass substrate. Further, the midframe is attached to the frame so that the frame limits thermal dimensional changes of the midframe in a first direction more than thermal dimensional changes of the midframe in a second direction.

### PRIORITY

This application claims the benefit of priority under 35 U.S.C. § 120 of U.S. Application No. 63/275,738 filed on Nov. 4, 2021, the content of which is relied upon and incorporated hereby by reference in its entirety.

### BACKGROUND

The disclosure relates to a glass article and, more particularly, to a glass article having a midframe configured to join a glass substrate to a frame.

Vehicle interiors include curved surfaces and can incorporate displays in such curved surfaces. The materials used to form such curved surfaces are typically limited to polymers, which do not exhibit the durability and optical performance of glass. As such, curved glass substrates are desirable, especially when used as covers for displays. Existing methods of forming such curved glass substrates, such as thermal forming, have drawbacks including high cost, optical distortion, and surface marking. Other low-temperature methods of forming such curved glass substrates have other manufacturing issues, such as processing bottlenecks or part reliability because of inherent stresses introduced by the forming process. Such issues are exacerbated when parts formed through low-temperature forming methods are subject to extreme temperature cycling and typical mechanical vibrations experienced during use.

### SUMMARY

According to an aspect, embodiments of the disclosure relate to a glass article. The glass article includes a glass substrate, a midframe, and a frame. The glass substrate has a first major surface and a second major surface in which the second major surface is opposite to the first major surface. The midframe is attached to the second major surface of the glass substrate. Further, the midframe is attached to the frame so that the frame limits thermal dimensional changes of the midframe in a first direction more than thermal dimensional changes of the midframe in a second direction

According to another aspect, embodiments of the disclosure relate to a glass article. The glass article includes a glass substrate having a first major surface and a second major surface. The second major surface is opposite to the first major surface. The glass article also includes a midframe attached to the second major surface of the glass substrate, and the glass article also includes a frame. The midframe is attached to the frame by either a plurality of discrete attachment points or in a manner that allows for relative movement between the midframe and the frame responsive to thermal expansion or contraction of the midframe.

According to still another aspect, embodiments of the disclosure relate to a method of manufacturing a glass article. In the method, a midframe is attached to a glass substrate having a first major surface and a second major surface. The midframe is attached to the second major surface. Further, in the method, the midframe is connected to a frame in a manner that allows for relative movement between the midframe and the frame responsive to thermal expansion or contraction of the midframe.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a vehicle interior with vehicle interior systems, according to exemplary embodiments.

FIGS. 2A and 2B depict a V-shaped and a C-shaped curved glass article, respectively according to an exemplary embodiment.

FIG. 3 depicts an exploded perspective view of a glass article and forming fixture, according to an exemplary embodiment.

FIG. 4 depicts steps of a method of forming a curved glass article incorporating a midframe, according to an exemplary embodiment.

FIG. 5 depicts a heat map of the tensile stress in the adhesive for a quadrant of the glass article based on position along the longitudinal and lateral edges of the glass article, according to an example embodiment.

FIG. 6 depicts a graph of the maximum principal stress as a function of normalized length of the longitudinal and lateral edges of the glass article, according to an example embodiment.

FIG. 7 depicts various potential discrete attachment points for joining the midframe to the frame, according to an example embodiment.

FIG. 8 depicts a first embodiment of a mechanical connection mechanism for joining a midframe to a frame, according to an example embodiment.

FIGS. 9 and 10 depict alignment posts of the midframe extending through alignment slots of the frame for positioning the midframe and constraining thermal dimensional changes of the midframe relative to the frame, according to example embodiments.

FIG. 11 depicts thermal strain for various glass substrate and midframe thicknesses, according to example embodiments.

FIGS. 12A and 12B depict a clip mechanism for joining the midframe to the frame, according to an example embodiment.

FIGS. 13A and 13B depict expansion joints formed into the midframe, according to example embodiments.

FIGS. 14A-14D depict various void structures formed into the midframe, according to example embodiments.

FIG. 15 depicts a porous midframe, according to an example embodiment.

FIG. 16 depicts a midframe including a retaining structure for positioning a film over a backlight unit mounted to a frame for an open cell display, according to an example embodiment.

FIG. 17 depicts geometric dimensions of a glass substrate, according to an example embodiment.

### DETAILED DESCRIPTION

Reference will now be made in detail to various embodiments of a glass article and method of forming same, examples of which are illustrated in the accompanying drawings. In general, the present disclosure is directed to a glass article having a glass substrate that is adhered to a flexible midframe, which mechanically connects the glass substrate to a rigid, structural frame. As will be described herein, the midframe provides various manufacturing advantages, especially for curved, cold-formed glass articles, but the midframe, being made of a flexible material, generally expands and contracts a greater amount than the glass substrate and the frame. To address the potential for thermal stress resulting from the differential in thermal expansion/contraction that could otherwise cause rupture of the adhesive layer joining the midframe to the glass substrate, a variety of midframe configurations are described below that allow for movement of the midframe relative to the frame in at least one direction. In particular, the midframe configurations described herein may permit the midframe to thermally expand and contract relative to the frame in at least one direction. For example, in embodiments, the midframe may be constrained from movement to a greater extent along short edges of the glass article than along longer edges of the glass article, as tensile stress in the adhesive layer may typically be higher along the shorter edges. Such lack of constraint along the longer edges beneficially prevents thermal expansion and contraction of the midframe from being unnecessarily inhibited, thereby reducing stresses placed on the midframe and improving durability and reliability. These and other aspects and advantages will be described in relation to the embodiments provided below and in the drawings. These embodiments are presented by way of example and not by way of limitation.

In order to provide context for the glass article and the process of forming the glass article described herein, exemplary embodiments of curved glass articles will be described in relation to the particular application of a vehicle interior system.

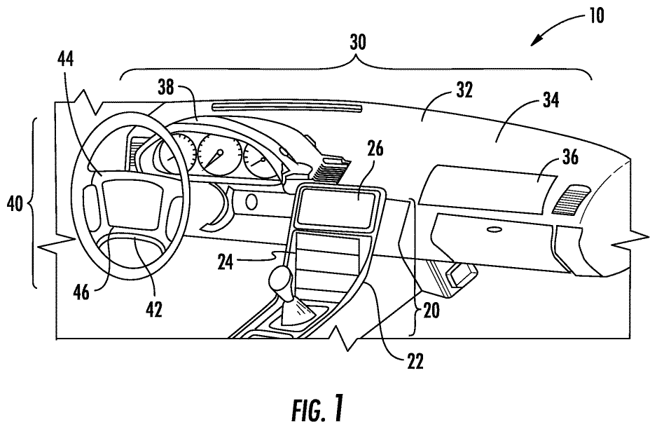

FIG. 1 shows an exemplary interior 10 of a vehicle that includes three different embodiments of vehicle interior systems 20, 30, 40. Vehicle interior system 20 includes a base, shown as center console base 22, with a curved surface 24 including a display 26. Vehicle interior system 30 includes a base, shown as dashboard base 32, with a curved surface 34 including a display 36. The dashboard base 32 typically includes an instrument panel 38 which may also include a display. Vehicle interior system 40 includes a base, shown as steering wheel base 42, with a curved surface 44 and a display 46. In one or more embodiments, the vehicle interior system includes a base that is an arm rest, a pillar, a seat back, a floor board, a headrest, a door panel, or any portion of the interior of a vehicle that includes a curved or flat surface.

The embodiments of the glass articles described herein can be used in each of vehicle interior systems 20, 30, 40, among others. In one or more such embodiments, the glass article discussed herein may include a cover glass substrate that also covers non-display surfaces of the dashboard, center console, steering wheel, door panel, etc. In such embodiments, the glass material may be selected based on its weight, aesthetic appearance, etc. and may be provided with a coating (e.g., an ink or pigment coating) including a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality when the display 26, 36, 38, 46 is inactive. Further, while the vehicle interior of FIG. 1 depicts a vehicle in the form of an automobile (e.g., cars, trucks, buses and the like), the glass articles disclosed herein can be incorporated into other vehicles, such as trains, sea craft (boats, ships, submarines, and the like), aircraft (e.g., drones, airplanes, jets, helicopters and the like), and spacecraft.

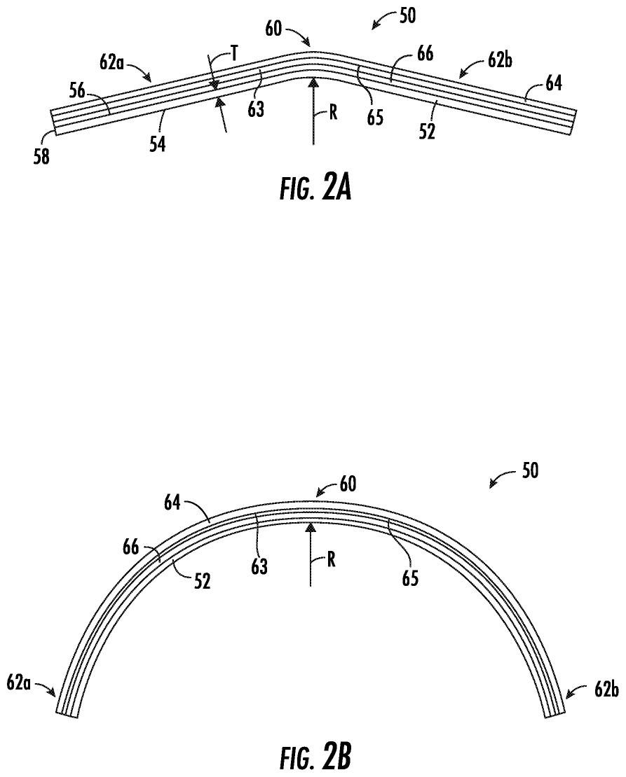

In embodiments, the surfaces 24, 34, 44 may be any of a variety of curved shapes, such as V-shaped or C-shaped as shown in FIGS. 2A and 2B, respectively. Referring first to FIG. 2A, a side view of an embodiment of a V-shaped glass article 50 is shown. The glass article 50 includes a glass substrate 52 having a first major surface 54, a second major surface 56 opposite to the first major surface 54, and a minor surface 58 joining the first major surface 54 to the second major surface 56. The first major surface 54 and the second major surface 56 define a thickness T of the glass substrate 52. In embodiments, the thickness T of in the glass substrate 52 is from 0.3 mm to 2 mm, in particular 0.5 mm to 1.1 mm. In a vehicle, the first major surface 54 faces the occupants of the vehicle.

In embodiments, the first major surface 54 and/or the second major surface 56 includes one or more surface treatments. Examples of surface treatments that may be applied to one or both of the first major surface 54 and second major surface 56 include an anti-glare coating, an anti-reflective coating, a coating providing touch functionality, a decorative (e.g., ink or pigment) coating, and an easy-to-clean coating.

As can be seen in FIG. 2A, the glass substrate 52 has a curved region 60 disposed between a first flat section 62a and a second flat section 62b. In embodiments, the curved region 60 has a radius of curvature R that is from 30 mm to a radius of curvature that is less than substantially flat or planar (e.g., R=10 m), from 30 mm to 5000 mm, from 30 mm to 2500 mm, from 30 mm to 1500 mm, or from 30 mm to 1000 mm. Further, as shown in FIG. 2A, the curved region 60 defines a concave curve with respect to the first major surface 54, but in other embodiments, the curved region 60 is instead a convex curve with respect to the first major surface 54.

In the glass article 50 of FIG. 2A, a midframe 63 is adhered to the second major surface 56 of the glass substrate 52. As mentioned above, the midframe 63 is configured for attachment to a rigid, structural frame 64. In this way, the midframe 63 can be considered an interface between the glass substrate 52 and the rigid frame 64. The midframe 63 is attached to the glass substrate 52 via an adhesive layer 66, and the frame 64 is attached to the midframe 63 using a mechanical connection as will be discussed below. In embodiments, the adhesive layer 66 joining the midframe 63 to the glass substrate 52 is a structural adhesive, such toughened epoxy, flexible epoxy, acrylics, silicones, urethanes, polyurethanes, and silane modified polymers. In embodiments, the adhesive layer 66 has a thickness of 2 mm or less between the midframe 63 and the glass substrate 52.

In one or more embodiments, the frame 64 may facilitate mounting the glass article 50 to a vehicle interior base (such as center console base 22, dashboard base 32, and/or steering wheel base 42 as shown in FIG. 1). In one or more embodiments, the frame 64 has a curved frame support surface 65 that may be used to hold the midframe 63 and glass substrate 52 in their curved shape (at least in the curved region 60). In embodiments, the glass substrate 52 is formed in such a way that the curved region 60 is not permanent. That is, the glass substrate 52 would spring back to a planar, non-curved (i.e., flat) configuration if the glass substrate 52 was not adhered to midframe 63 and connected to the rigid frame 64. Thus, the glass substrate 52 is stressed to produce the curvature and remains stressed during the life of the glass article 50.

FIG. 2B depicts another embodiment of a glass article 50, in particular a C-shaped glass article 50. As compared to the V-shaped glass article 50 of FIG. 2A, the C-shaped glass article 50 of FIG. 2B has a larger curved region 60 and shorter flat sections 62a, 62b. The V-shape and C-shape are but two examples of curved glass articles 50 that can be created according to the present disclosure. In other embodiments, the glass articles 50 can include curved regions 60 having opposing curvatures to create an S-shape, a curved region 60 followed by a flat section 62a to create a J-shape, and curved regions 60 separated by a flat section 62a to create a U-shape, among others.

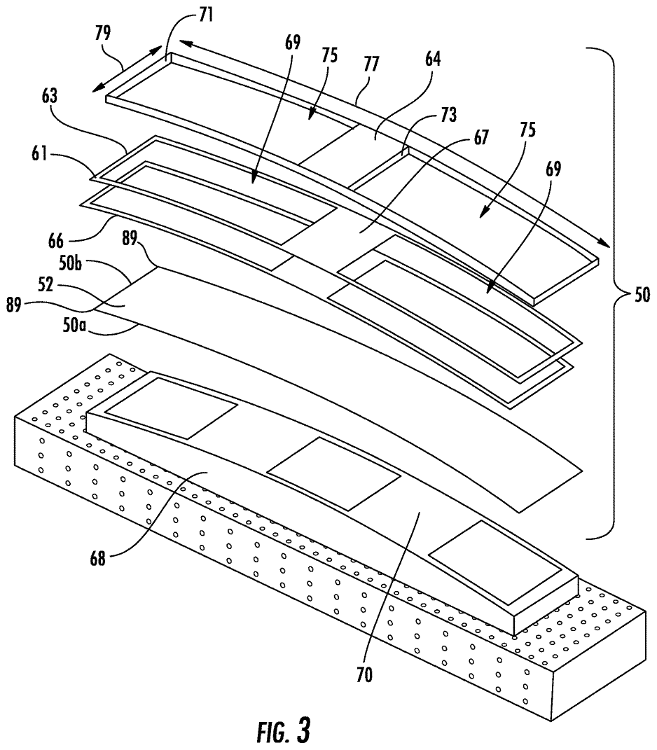

FIG. 3 depicts an exploded view of an example embodiment of the glass article 50. As can be seen in the example embodiment shown in FIG. 3, the midframe 63 and frame 64 may not cover the entire second major surface 56 of the glass substrate 52. Instead, the midframe 63 and frame 64 only cover a portion of the second major surface 56. In one or more embodiments, the midframe 63 may include a border 61 extending around a perimeter of the glass substrate 52. In one or more embodiments, the border 61 may be substantially coextensive with the perimeter of the glass substrate 52, or in one or more other embodiments, the border 61 may inwardly offset from the perimeter of the glass substrate 52. Further, in one or more embodiments, the midframe 63 includes at least one pillar 67 extending between opposites sides of the border 61. The border 61 and pillar 67 may define one or a plurality of apertures 69 designed to accommodate a display module. In one or more other embodiments, the midframe 63 and frame 64 does not include a pillar 67, and the border 61 may define a single large aperture 69 to accommodate a display module (e.g., as shown in FIG. 4).

As shown in FIG. 3, the adhesive layer 66 may be substantially continuous and coextensive in the shape of the midframe 63. However, in one or more other embodiments, such as will be discussed below, the midframe 63 may be discontinuous, and therefore, the adhesive layer 66 joining the midframe 63 to the glass substrate 52 may also be discontinuous, having discontinuities in the same positions as the midframe 63. Further, in one or more embodiments, the adhesive layer 66 may include other discontinuities such that the midframe 63 is periodically joined to the glass substrate 52 in regular or irregular intervals.

In one or more embodiments, the frame 64 has substantially the same shape as the midframe 63. For example, as shown in FIG. 3, the frame 64 may also include a border 71 and, in embodiments, one or a plurality of pillars 73 that define at least one aperture 75 designed to accommodate a display module. However, in one or more other embodiments, the frame 64 may include a substantially continuous back plate, e.g., for mounting a backlight unit.

In one or more embodiments, the glass article 50 has a first axis 77 extending along a longest edge of the glass article 50 and a second axis 79 transverse, in particular perpendicular, to the first axis 77 that extends along a shortest edge of the glass article 50. Herein, the longest edge(s) will be referred to as the longitudinal edge(s) 50a, and the shortest edge(s) will be referred to as the lateral edge(s) 50b. In this way, the first axis 77 can be considered the longitudinal axis of the glass article 50, and the second axis 79 can be considered the lateral axis of glass article 50. In embodiments, the perimeter shape of each component of the glass article 50 (glass substrate 52, midframe 63, and frame 64) are the same, and thus, in such embodiments, the longitudinal edges 50a and lateral edges 50b of the glass article 50 also correspond the longitudinal and lateral edges of the glass substrate 52, the midframe 63, and the frame 64, respectively. In the glass article 50 shown in the figures, each component, including the glass substrate 52, the midframe 63, and the frame 64, defines a rectangular perimeter such that there are two opposing longitudinal edges that are perpendicular to two opposing lateral edges. Further, in the embodiment depicted, the glass article 50 is curved along the longitudinal axis 77. The frame 64 may retain the glass substrate 52 and the midframe 63 in the depicted curved configuration. In such embodiments, the curvature of the glass article 50 may create stress in the adhesive layer 66, where the substrate 52 tries to pull away from the midframe 63 and frame 64 along the lateral axis 79 at the lateral edges and potentially along the longitudinal axis 77 at locations proximal to corners 89 where the longitudinal edges 50a meet the lateral edges 50b.

In embodiments, the glass articles 50 according to the present disclosure are formed by cold-forming techniques. In general, the process of cold-forming involves application of a bending force to the glass substrate 52 while the glass substrate 52 is situated on a fixture 68 as shown in the exploded view of FIG. 3. As can be seen, the fixture 68 has a curved forming surface 70, and the glass substrate 52 is bent into conformity with the curved forming surface 70. Advantageously, it is easier to apply surface treatments to a flat glass substrate 52 prior to creating the curvature in the glass substrate 52, and cold-forming allows the treated glass substrate 52 to be bent without destroying the surface treatment (as compared to the tendency of high temperatures associated with hot-forming techniques to destroy surface treatments, which requires surface treatments to be applied to the curved article in a more complicated process). In embodiments, the cold forming process is performed at a temperature less than the glass transition temperature of the glass substrate 52. In particular, the cold forming process may be performed at room temperature (e.g., about 20° C.) or a slightly elevated temperature, e.g., at 200° C. or less, 150° C. or less, 100° C. or less, or at 50° C. or less.

FIG. 4 depicts a process flow of an example embodiment of a method 100 of forming a curved glass article 50. In a first step 101 of the method, a glass substrate 52 having a display module 72 mounted on the second major surface 56 is provided. In embodiments, the display module 72 may be, e.g., a light-emitting diode (LED) display, an organic LED (OLED) display, a micro-LED display, a liquid crystal display (LCD), or a plasma display. In embodiments, the display module 72 is mounted to the second major surface 56 of the glass substrate 52 using an optically clear adhesive (not shown). The adhesive layer 66 is applied to the second major surface 56 of the glass substrate 52 around the display module 72, and the midframe 63 is adhered to the glass substrate 52 using the adhesive layer 66. In the embodiment depicted, the display module 72 is flexible and is attached to the glass substrate 52 before the glass substrate 52 is bent, but in other embodiments, the display module 72 may be a curved display module 72 and attached to the glass substrate 52 near the end or after the cold-forming process. Further, in one or more embodiments, the display module 72 is attached to the midframe 63 or frame 64 instead of the glass substrate 52.

In a second step 102, the adhesive layer 66 is allowed to cure on the glass substrate 52 to join the midframe 63 to the glass substrate 52. As depicted in the second step 102, the midframe 63 includes an aperture 69 that accommodates the display module 72 such that the display module 72 is surrounded by the border 61 of the midframe 63. The adhesive layer 66 substantially matches the shape of the midframe 63 and also surrounds the display module 72. Advantageously, the display module 72 and midframe 63 can be bonded to the glass substrate 52 while the glass substrate 52 is in the flat configuration prior to bending the glass substrate 52 over the fixture 68. As mentioned above, no specialized processing equipment (such as a fixture 68) is needed to this point in the method 100, and while curing, the glass substrate 52 and midframe 63 can be queued and densely packed. Moreover, minimal or no clamping force is required while curing the adhesive layer 66 in the flat configuration, and technologies that accelerate curing (application of even heat or electromagnetic radiation) are easier to apply to flat components.

In a third step 103, the glass substrate 52 having the display module 72 and midframe 63 bonded thereto is cold-bent over the forming surface 70 of the fixture 68. In embodiments, cold-bending involves utilizing a press to apply a pressure to the glass substrate 52 so as to conform the glass substrate 52 to the curvature of the forming surface 70. In embodiments, the glass substrate 52 is held in the cold-bent position using vacuum pressure drawn through the fixture 68. In one or more embodiments, the fixture 68 having a vacuum drawn therethrough is a vacuum chuck. When the glass substrate 52 is bent, the midframe 63 is also bent. Further, if the display module 72 is provided across a curved region 60, then the display module 72 is also bent with the glass substrate 52.

In a fourth step 104, the frame 64 is attached to the midframe 63 while the glass substrate 52 is in the cold-bent configuration on the fixture 68. As mentioned above and as will be discussed below, the midframe 63 may be mechanically connected to the frame 64. In this way, the mechanical connection between the frame 64 and the midframe 63, which has already been adhered to the glass substrate 52, holds the glass substrate 52 in the cold-bent configuration. Conventionally, a cold-bent glass article had a frame bonded directly to the glass substrate, which held the glass substrate in the cold-bent configuration. Constructing the glass article in this way required the adhesive bonding the frame to the glass substrate to cure before the glass article could be removed from the fixture. Curing of the adhesive could take up to two hours to complete, which creates a processing bottleneck in which the forming fixtures cannot be used to cold-bend glass articles. Accordingly, by bonding the midframe 63 to the glass substrate 52 in the flat configuration and then bending the combined midframe 63 and glass substrate 52 over the fixture 68, the adhesive layer 66 does not have to cure while the glass article 50 is on the fixture 68. Instead, as shown in step 105, the glass article 50 can be removed from the fixture 68 upon securing the frame 64 to the midframe 63, freeing the fixture 68 to be used for another cold-bending operation.

In one or more embodiments, the midframe 63 is considered flexible relative to the rigid frame 64. In one or more embodiments, the midframe 63 is made from a material having an elastic modulus of 40 GPa or less, 10 GPa or less, or 4 GPa or less. In one or more embodiments, the midframe 63 may be made of a polymeric or composite material. In example embodiments, the midframe 63 is made from one of or a blend of two or more of polycarbonate (PC), acrylonitrile butadiene styrene (ABS), poly (methyl methacrylate) (PMMA), polyamide (PA), polypropylene (PP), polyurethane (PUR), polyphenyl ether (PPE), polyvinylchloride (PVC), polystyrene (PS), polyethylene (PE), polyoxymethylene (POM), polybutylene terephthalate (PBT), polyethylene terephthalate (PET), acrylonitrile styrene acrylate (ASA), or composite of one or more of the forgoing materials with a fiber, such as carbon fiber or glass fiber.

In one or more embodiments, the frame 64 is rigid relative to the midframe 63. In one or more embodiments, the frame 64 is made from a material having an elastic modulus higher than that of the midframe 63, in particular an elastic modulus of at least 1 GPa, at least 5 GPa, or at least 20 GPa. In one or more embodiments, the frame 64 is made from a metal, such as an aluminum alloy, a magnesium alloy, a steel alloy, an engineering plastic, or a fiber-reinforced composite plastic.

In one or more embodiments, the glass substrate 52 comprises a glass material, such as soda lime glass, aluminosilicate glass, borosilicate glass, boroaluminosilicate glass, alkali-containing aluminosilicate glass, alkali-containing borosilicate glass, or alkali-containing boroaluminosilicate glass. In one or more embodiments, the glass substrate 52 may be strengthened (e.g., by thermal tempering or ion-exchange treatment) or unstrengthened.

Because of the different materials used for the glass substrate 52, midframe 63, and frame 64, these components may undergo different dimensional changes as a result of temperature cycling. In particular, the materials used for the glass substrate 52, midframe 63, and frame 64 are likely to have different coefficients of thermal expansion, meaning that the materials will expand at hot temperatures or contract at cold temperatures at different rates. The different rates of expansion/contraction create stress in the adhesive layer 66, which can lead to delamination of the glass substrate 52 if not accommodated in the design of the glass article 50. Further, the midframe 63, if not allowed some amount of expansion or contraction could buckle, causing bulging against the glass substrate 52 and affecting the optical properties and appearance of the glass article 50.

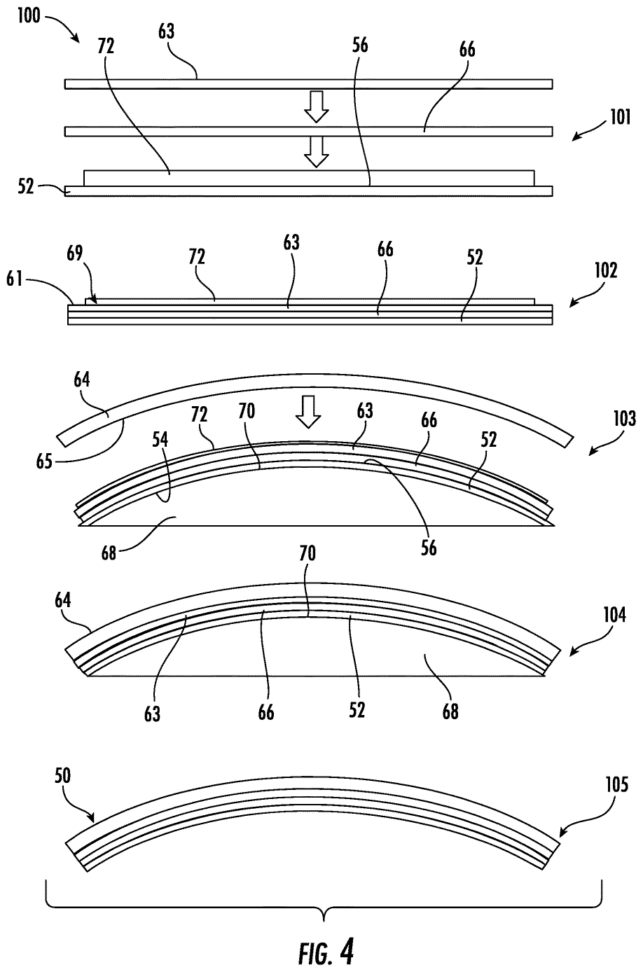

According to the present disclosure, the midframe 63 and frame 64 are connected to one another to permit the midframe 63 to expand or contract relative to the frame 64 while still maintaining a mechanical connection between the midframe 63 and the frame 64. In embodiments, the midframe 63 and frame 64 are connected in a manner that allows for relative movement between the midframe 63 and frame 64 in response to thermal expansion or contraction of the midframe 63. For example, in embodiments, the midframe 63 is constrained against thermal dimensional changes relative to the frame 64 along the longitudinal axis (e.g., the first axis 77 of FIG. 3) of the glass article 50 to a lesser extent than along the lateral axis (e.g., the second axis 79 of FIG. 3) of the glass article 50. Additionally or alternatively, according to certain embodiments discussed below, the midframe 63 is provided with stress relief expansion joints, voids, or porosity to allow for thermal dimensional changes without creating thermal stresses significant enough to cause delamination of the glass substrate 52. The embodiments that follow describe various example structures (e.g., modes of connection, points of connection, expansion joints, pores, voids, webs) that may be used to reduce stress accumulation from the inhibition of the thermal expansion and contraction of the midframe 63 due to attachment to the frame 64. It should be understood that various combinations of these structures may be used in combination with one another in accordance with the present disclosure. While embodiments of each structure are described herein serially, any combination of the structures described herein with respect to FIGS. 5-16 may be used in combination with one another.

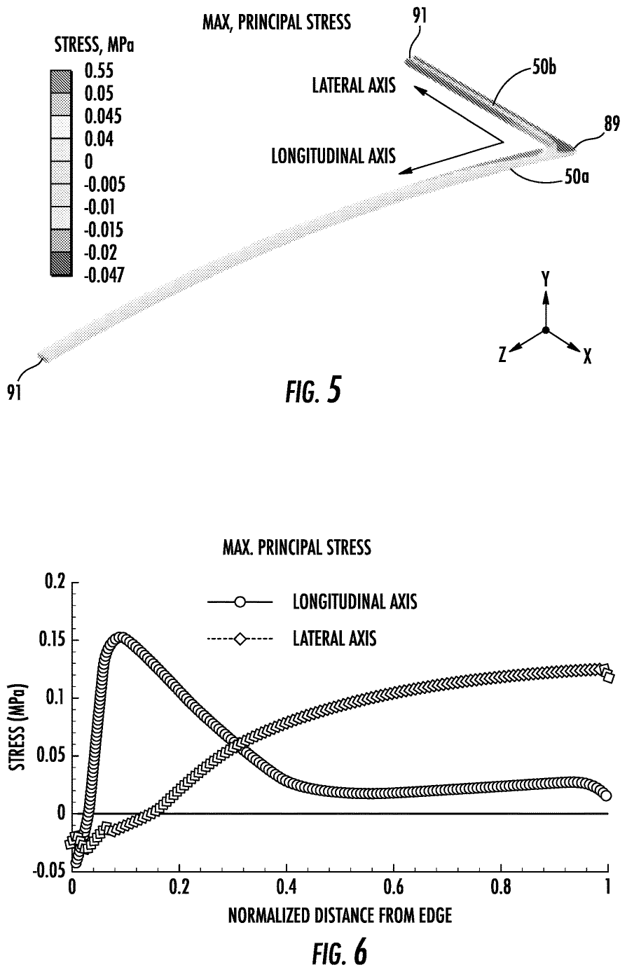

The thermal stress resulting from expansion and contraction is additional to the tensile stress on the adhesive layer 66 present from the cold-forming process. FIG. 5 depicts a heatmap representation of the maximum principal stress on the adhesive layer 66 in one quadrant of the glass article 50. In particular, FIG. 5 depicts one half of the lateral edge 50b and one half of the longitudinal edge 50a of the glass article 50. As shown in FIG. 5, the maximum principal stress is highest on the lateral edge 50b and on part of the longitudinal 50a proximal to the lateral edge 50b. FIG. 6 depicts a graph of the maximum principal stress as a function of normalized distance from the longitudinal edge 50a and from the lateral edge 50b of the quadrant depicted in FIG. 5. In particular, the normalized distance of 0 corresponds to the corner 89 of the quadrant, and the normalized length of 1 corresponds to a midpoint 91 of each axis. As shown in FIG. 6, the maximum principal stress on the lateral edge 50b reaches 0.05 MPa at about 0.3 of the normalized length and continues to increase until the midpoint 91 of the lateral edge 50b is reached. The maximum principal stress on the longitudinal edge 50a spikes to greater than 0.15 MPa at about 0.1 of the normalized length and then quickly tapers to below 0.05 MPa at about 0.3 of the normalized length. The quadrant described in FIGS. 5 and 6 is representative of each quadrant of the glass article 50.

In one or more embodiments, the midframe 63 is connected to the frame 64 at a plurality of discrete attachment points around the perimeter of the frame 64. In particular, the midframe 63 is connected to the frame 64 at locations where the principal stress on the adhesive is the highest. In these regions, additional thermal stress on the adhesive layer 66 from expansion and contraction during thermal cycling has the potential to cause the total stress on the adhesive layer 66 to rise above the adhesive strength, which, if not accounted for in the design of the glass article 50, could cause the adhesive layer 66 to prematurely fail. From FIGS. 5 and 6, it can be seen that the maximum principal stress is along most of the lateral edge 50b and at a positon proximal to the corner 89 on the longitudinal edge 50a.

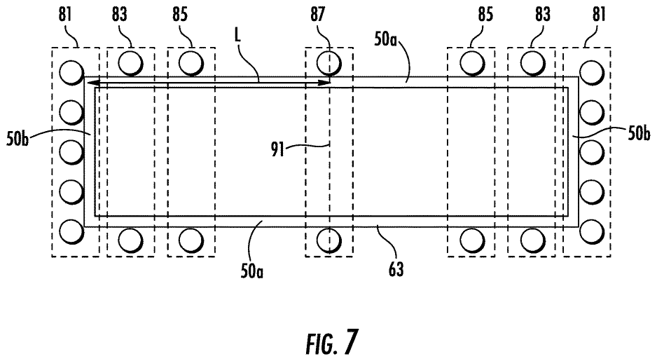

FIG. 7 depicts a variety of possible discrete attachment points around the perimeter of the midframe 63 where the midframe 63 could be joined to the frame 64. In general, the midframe 63 is attached to the frame 64 with a sufficient number of mechanisms and positioned in a manner to maintain a desired shape match between the curved support surface 65 of the frame 64 and the glass substrate 52 (e.g., a shape deviation of +/−0.3 mm). The number and placement of the attachment points may vary based on a particular design of a glass article 50. In an embodiment, the midframe 63 is joined to the frame 64 at least at a first plurality of discrete attachment points 81 spaced along the lateral edges 50b of midframe 63. In one or more embodiments, the first plurality of discrete attachment points 81 are uniformly distributed along the lateral edges of the midframe 63. In one or more embodiments, the first plurality of discrete attachment points 81 are provided every 50 mm to 100 mm along the lateral edges of the midframe 63. In one or more further embodiments, the midframe 63 is also joined to the frame 64 at a second plurality of discrete attachment points 83. In such embodiments, the second plurality of discrete attachment points 83 correspond to the approximate location of the peak in principal stress along the longitudinal edges. In particular, for a length L between each corner and the midpoint 91 of each longitudinal edge, the second plurality of discrete attachment points 83 is located between about 0.075 L and about 0.15 L, in particular about 0.09 L and about 0.12 L, from the corner on the longitudinal edges.

In still further embodiments, the midframe 63 is also joined to the frame 64 at a third plurality of discrete attachment points 85. In one or more embodiments, the third plurality of discrete attachment points 85 is located between about 0.25*L and 0.75*L, in particular about 0.3*L and L, from the corner on the longitudinal edges. Still further, in embodiments, the midframe 63 is also joined to the frame 64 at a fourth plurality of discrete attachment points 87. In one or more embodiments, the fourth plurality of discrete attachment points 87 is located at about the respective midpoints (e.g., within 0.1*L of the midpoints) of the longitudinal edges.

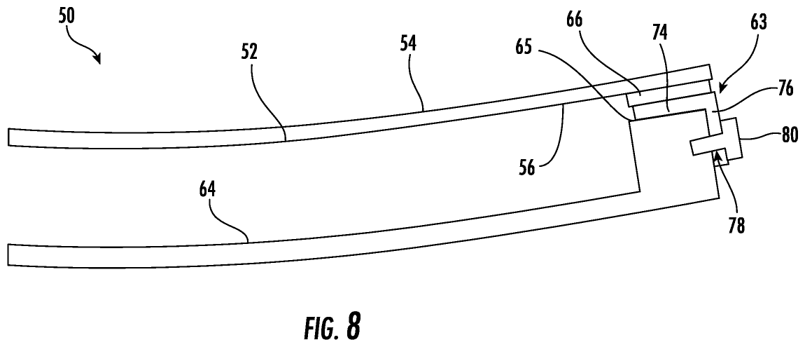

FIG. 8 depicts an example embodiment of a midframe 63 configuration for attachment to the frame 64 at any of the first, second, third, or fourth plurality of discrete attachment points 81, 83, 85, 87 in cross-section. As shown in FIG. 8, the glass substrate 52 has been cold bent, and the midframe 63 is adhered to the second major surface 56 of the glass substrate 52 via adhesive layer 66. In one or more embodiments, the depicted cross-section of the midframe 63 is L-shaped including a first member 74 generally parallel to the second major surface 56 of the glass substrate 52 and a second member 76 arranged generally perpendicular to the first member 74 and extending away from the glass substrate 52 towards the frame 64. The first member 74 is adhered to the glass substrate 52, and the second member 76 includes an aperture 78 through which a fastener 80 (e.g., pin, screw, bolt, rivet, post, protrusion, etc.) may be inserted to secure the midframe 63 to the frame 64. As shown in FIG. 8, the fastener 80 secures the midframe 63 to the exterior of the frame 64. In embodiments, the first member 74 extends around the entire perimeter of the frame 64. In embodiments, the second member 76 extends around the entire perimeter of the frame 64 and includes a plurality of apertures 78 through which fasteners 80 can be inserted to join the midframe 63 to the frame 64. In such embodiments, the second member 76 may provide a decorative feature to hide the frame 64. In other embodiments, the second member 76 only extends from the first member 74 at locations where an aperture 78 through which a fastener 80 is inserted to join the midframe 63 to the frame 64. The midframe 63 may include a plurality of the second members 76 at locations corresponding to points of connection between the midframe 63 and the frame 64.

While FIG. 8 depicts the midframe 63 connected to the exterior of the frame 64, the midframe 63 may be connected to the interior of the frame 64 in other embodiments. Further, while a fastener 80 is used to connect the midframe 63 to the frame 64, the midframe 63 may be connected to the frame 64 using other attachment mechanisms as will be discussed below.

FIG. 9 depicts another embodiment of a mechanism for joining the midframe 63 to the frame 64. In one or more embodiments, the midframe 63 includes a plurality of first alignment posts 82 that extend through first slots 84 in the frame 64. The alignment posts 82 are examples of the fastener 80 depicted in FIG. 8. That is, in embodiments, the alignment posts 82 may be included at any of the first, second, third, or fourth plurality of discrete attachment points 81, 83, 85, 87 depicted in FIG. 7. In embodiments, the alignment posts 82 and first slots 84 are disposed at locations other than the first, second, third, or fourth plurality of discrete attachment points 81, 83, 85, 87 depicted in FIG. 7. The view shown in FIG. 9 is of a rear surface of the frame 64, and thus, the midframe 63 is covered by the frame 64 such that only the alignment posts of the midframe 63 are seen extending through the slots 84 of the frame 64. In one or more embodiments, the midframe 63 includes first alignment posts 82 at least on the lateral edges. The first alignment posts 82 each have a first length L1 and a first width W1. The first length L1 is parallel to the lateral axis, and the first width W1 is parallel to the longitudinal edge 50a. The first slots 84 have a second length L2 and a second width W2. The second length L2 is parallel to the lateral edge 50b, and the second width W2 is parallel to the longitudinal edge 50a. In one or more embodiments, the first slots 84 in the frame 64 on the lateral edges have a second length L2 that is substantially equal to the first length L1 of the first alignment post 82, and the first slots 84 in the frame 64 on the lateral side have a second width W2 that is larger than the first width W1 of the first alignment post 82.

In this way, the thermal expansion of the midframe 63 is constrained against thermal expansion and contraction to a lesser extent along the longitudinal axis than along the lateral axis. That is, expansion and contraction is limited in the direction of the lateral axis because the first alignment posts 82 abut the first alignment slots 84 in that direction, but expansion and contraction is not limited in the direction of the longitudinal axis because clearance is provided between the first alignment posts 82 and the first alignment slots 84 in that direction. In one or more embodiments, the second width W2 of the first slot 84 is up to 2 mm wider (i.e., providing 1 mm of clearance on either side of the first alignment posts 82), in particular up to 4 mm wider (i.e., providing 2 mm of clearance on either side of the first alignment posts 82), than first width W1 of the first alignment post 82. The difference between W1 and W2 may vary in particular embodiments depending on the materials out of which the frame 64 and midframe 63 are constructed and the dimensions of those components.

As shown in FIG. 9, the midframe 63 may also include one or more second alignment posts 86 on at least one of the longitudinal edges of the midframe 63. In one or more embodiments, the second alignment post 86 is positioned at about a midpoint of the longitudinal edge. Further, the second alignment post 86 extends through a corresponding second slot 88 in the frame 64. In one or more embodiments, the second alignment post 86 has a third length L3 parallel to the lateral edge 50b and a third width W3 parallel to the longitudinal edge 50a, and the second slot has a fourth length L4 parallel to the longitudinal edge 50a and a fourth width W4 parallel to the lateral edge 50b. In one or more embodiments, the fourth width W4 is substantially equal to the third width W3, and the fourth length L4 is substantially equal to the third length L3. In this way, midframe 63 at the midpoint is constrained against thermal expansion and contraction along the longitudinal axis and along the lateral axis. That is, thermal dimensional change is limited in both directions because the second alignment post 86 abuts the second alignment slot 88 in both directions. Such constraint beneficially maintains the structural relationship between the frame 64 and the midframe 63 by preventing misalignment while adding minimal amounts of stress induced by thermal expansion/contraction, as the geometric center of the midframe 64 may represent a region of minimal dimensional change. In the embodiment depicted, the second alignment post 86 is depicted as cross-shaped, but in one or more other embodiments, the second alignment post 86 may be circular, rectangular, square, or other polygonal or curved shapes. Further, the second slot 88 may be the same shape as the second alignment post 86 or a different shape. For example, as shown in FIG. 9, the second alignment post 86 is cross-shaped, and the second slot 88 is square-shaped.

FIG. 10 depicts another embodiment of a second alignment post 86 of the midframe 63 extending through a second slot 88 of the frame 64. In the embodiment depicted in FIG. 10, the fourth width W4 of the second slot 88 is substantially the equal to the third width W3 of the second alignment post 86, and the fourth length L4 is greater than the third length L3. In this way, the midframe 63 is not constrained against thermal expansion or contraction along the lateral axis at the midpoint of the midframe 63 but is constrained against thermal expansion or contraction along the longitudinal edge 50a at the midpoint of the midframe 63. That is, thermal dimensional change is limited in the direction of the longitudinal axis because the second alignment post 86 abuts the second alignment slot 88 in that direction, but thermal dimensional change is not limited in the direction of the lateral axis because the clearance is provided between the second alignment post 86 and the second alignment slot 88 in that direction. In one or more embodiments, the fourth length L4 of the second slot 88 is up to 2 mm longer, in particular up to 4 mm longer, than third length L3 of the second alignment post 86.

Advantageously, the clearance that the slots 84, 88 provide for the alignment posts 82, 86 is sufficient to accommodate expected thermal strain for experienced by a midframe 63 adhered to the glass substrate 52. The adhesive layer 66 joining the midframe 63 and the glass substrate 52 may constrain thermal expansion and contraction of the midframe 63. The dimensional change of the bonded midframe 63 and glass substrate 52 is given by the following equation (equation 1):

$$Δ L = L ( \frac{\frac{{E}_{g} {t}_{g}}{{E}_{p} {t}_{p}} Δ T {α}_{g} + Δ T {α}_{p}}{\frac{{E}_{g} {t}_{g}}{{E}_{p} {t}_{p}} + 1} )$$

where ΔL is the dimensional change in length experienced by the midframe 63 and glass substrate 52 as a result of thermal expansion or contraction, L is the original length of the midframe 63 and glass substrate 52, E_{g} is the elastic modulus of the glass substrate 52, t_{g} is the thickness of the glass substrate 52, α_{g} is the coefficient of thermal expansion of the glass substrate 52, Eₚ is the elastic modulus of the midframe 63, tₚ is the thickness of the midframe 63, αₚ is the coefficient of thermal expansion of the midframe 63, and ΔT is the change in temperature. In embodiments, the clearance provided via the combinations of slots and posts described herein with respect to FIGS. 9 and 10 (e.g., the difference between W1 and W2) is at least equal to ΔL in equation 1.

FIG. 11 is a graphical representation of the thermal strain percentage (ΔL/L×100) based on the thicknesses (t_{g}, tₚ) of the glass substrate 52 and the midframe 63 on the midframe 63 as a result of thermal expansion and contraction of the glass article 50. The thermal strain was measured between room temperature and 95° C. and room temperature and −40° C. The elastic modulus E_{g} of the glass substrate 52 used to generate the graph was 76.7 GPa, which is characteristic of a strengthened aluminosilicate glass, and the elastic modulus Eₚ of the midframe 63 used to generate the graph was 2.27 GPa, which is characteristic of a PC/ABS blend used for the midframe 63. As can be seen in FIG. 11, the thermal strain is greatest where the glass substrate 52 is the thinner (toward the left of the graph) and where the midframe 63 is thickest (toward the top of the graph). However, even at a glass substrate 52 thickness t_{g} of 0.5 mm and a midframe 63 thickness tₚ of 3 mm, the thermal strain is 0.12%, which corresponds to 1.2 mm of expansion/contraction for a part having a length of 1000 mm. Thus, a clearance provided by the alignment posts 82, 86 within the slots 84, 88 of at least 1.0 mm (e.g., at least 1.2 mm, at least 1.5 mm, at least 1.7 mm, at least 2.0 mm) is sufficient to accommodate the thermal strain of the midframe 63 adhered to the glass substrate 52.

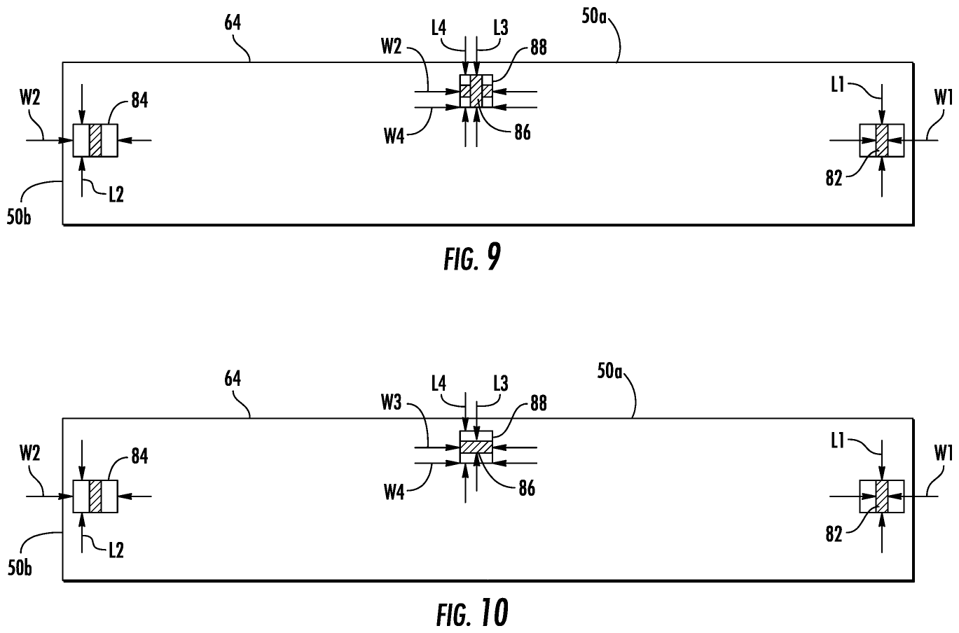

FIGS. 12A and 12B depict another embodiment of a mechanism for attaching the midframe 63 to the frame 64. The mechanism depicted in FIGS. 12A and 12B are example embodiments of the fastener 80 depicted in FIG. 8. That is, in embodiments, the mechanism may be included at any of the first, second, third, or fourth plurality of discrete attachment points 81, 83, 85, 87 depicted in FIG. 7. Referring first to FIG. 12A, a cross-sectional view of a clip mechanism 90 is shown. The clip mechanism 90 includes an angled post 92 that extends from an exterior edge 94 of the frame 64. The angled post 92 forms an angle θ with respect to the exterior edge 94. In one or more embodiments, the angle θ is from 50° to 80°. The midframe 63 includes a ring clip 96 configured to engage the angled post 92. In particular, the ring clip 96 of the midframe 63 catches within a recess 98 formed between the angled post 92 and the exterior edge 94. This prevents the ring clip 96 from slipping over angled post 92 during thermal expansion. Conventionally, clip mechanisms used to join components of a glass article did not include a recess, and the post formed a right angle with the exterior surface of the frame. As such, during expansion, one component could slip past the other, potentially decoupling the components.

Referring now to FIG. 12B, a front view of the clip mechanism 90 is depicted. As can be seen in FIG. 12B, the angled post 92 has a first width W1 that is parallel to the longitudinal edge 50b. Further, the ring clip 96 has a second width W2 on an interior of the surface 100 of the ring clip 96. The second width W2 is parallel to the longitudinal edge 50b. In one or more embodiments, the second width W2 of the ring clip 96 is greater than the first width W1 of the angled post 92. In one or more embodiments, the second width W2 is up to 2 mm greater than the first width W1 (i.e., 1 mm of clearance is provided on each side of the angled post 92), and in one or more other embodiments, the second width W2 is up to 4 mm greater than the first width W1 (i.e., 2 mm of clearance is provided on each side of the angled post 92). In one or more embodiments, the clip mechanisms 90 on the longitudinal edge of the glass article 50 are provided with clearance between the ring clip 96 and angled post 92 for unconstrained expansion and contraction along the longitudinal axis. In one or more embodiments, the clip mechanisms 90 on the lateral side of the glass article 50 are constrained against expansion along the lateral axis.

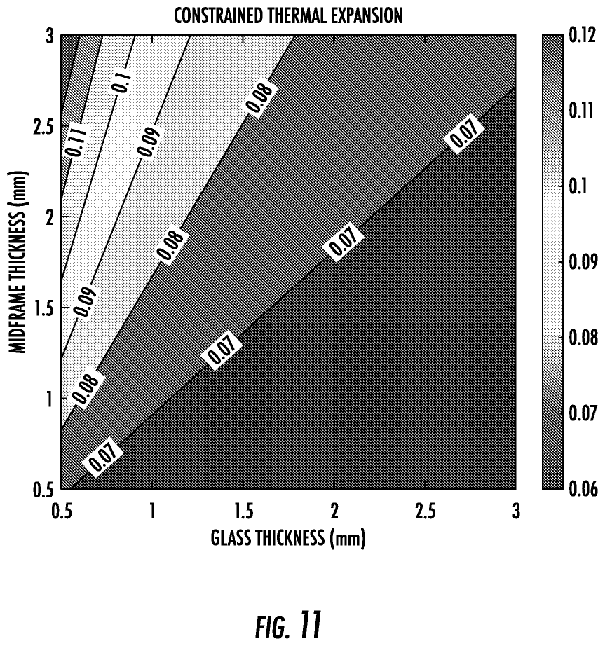

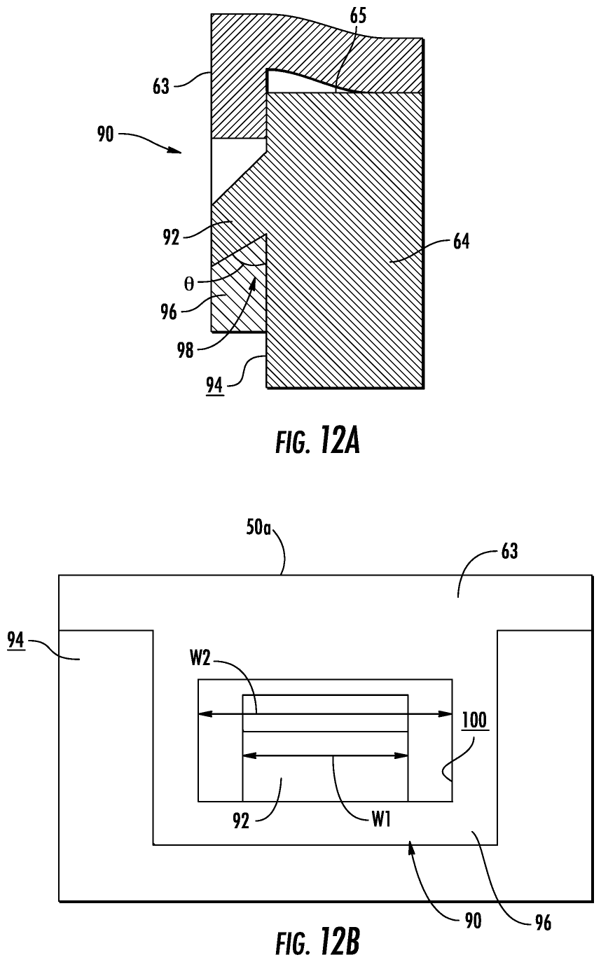

According to another embodiment, thermal stress that may be caused by expansion and contraction of the midframe 63 is counteracted by providing one or more expansion joints in the midframe 63. FIG. 13A depicts a top view of a first embodiment of an expansion joint 102 in which a break is provided between a first section 104a and a second section 104b of the midframe 63. The first section 104a and the second section 104b may be portions of the longitudinal or vertical edges of the midframe 63. In the depicted embodiment, the first section 104a has as first endface 106a, and the second section 104b has a second endface 106b. The first endface 106a and the second endface 106b are complementary. As shown in FIG. 13A, the first endface 106a and the second endface 106b extend from a first surface 108 (corresponding to an interior or exterior surface) of the midframe 63 to a second surface 110 (corresponding to the other of the interior or the exterior surface) of the midframe 63. In one or more embodiments, the first endface 106a forms an acute angle with the first surface 108 and an obtuse angle with the second surface 110. In one or more embodiments, the second endface 106b forms an obtuse angle with the first surface 108 and an acute angle with the second surface 110. Because of the break between the sections 104a, 104b of the midframe 63 and the complementary endfaces 106a, 106b, the expansion stress pushing the endfaces 106a, 106b together is diverted 90° to prevent buckling of the midframe 63.

FIG. 13B depicts another embodiment of an expansion joint 102 in which the first endface 106a is provided with a protrusion 112 and the second endface 106b is provided with a complementary recess 114. As can be seen in FIG. 13B, the protrusion 112 is rounded with a curvature, and the recess 114 has a matching curvature. The complementary protrusion 112 and recess 114 help to ensure that the endfaces 106a, 106b maintain alignment during both expansion and contraction.

In one or more embodiments, the midframe 63 comprises at least one expansion joint 102 per longitudinal edge 50a. In one or more embodiments, the midframe 63 comprises at least two expansion joints 102 per longitudinal edge 50a. Additionally, in one or more embodiments, the midframe 63 may comprise one or mor expansion joints 102 on each lateral edge 50b. In one or more embodiments, the expansion joints 102 are used to divide the length of the midframe 63, e.g., placed at the symmetry axis of the midframe 63 or placed at regular intervals until the edge of the frame.

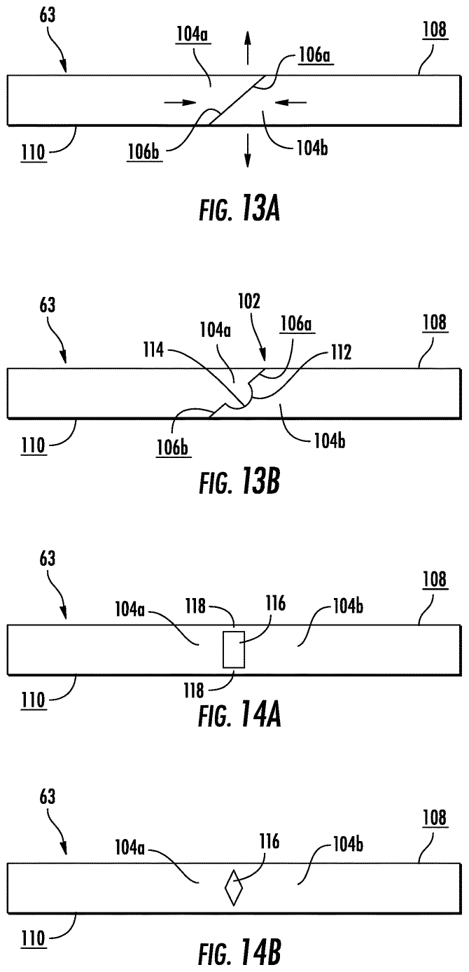

According to further embodiments, the thermal stress can be relieved by providing a plurality of voids 116 in the midframe 63 as shown in FIGS. 14A-14D. The voids 116 may extend through a thickness of the midframe 63. FIG. 14A depicts an embodiment in which the void 116 is rectangular defining a web 118 at each of the first surface 108 and the second surface 110. The webs 118 maintain connection between the first section 104a and the second section 104b during expansion and contraction of the midframe 63. The webs 118 also maintain structural integrity of the midframe 63 through its thickness. FIG. 14B depicts an embodiment in which the void is shaped as a diamond. FIG. 14C depicts an embodiment in which a plurality of rectangular voids 116, in particular three rectangular voids 116, are provided between the first surface 108 and the second surface 110. The three voids 116 create four webs 118: one at the first surface 108, one at the second surface 110, and two webs 118 intermediate of the first and second surfaces 110, 112. FIG. 14D depicts an embodiment in which the webs 118 are angled between the first section 104a and the second section 104b. As can be seen in FIG. 14D, the three webs 118 define two interior voids 116, and the first section 104a and the second section 104b are not connected at the first surface 108 or the second surface 110.

According to still another embodiment, the thermal stress can be relieved by providing a midframe 63 that is a porous material 117 or comprises sections of a porous material 117 as shown in FIG. 15. In one or more embodiments, the porous material 117 or sections of porous material 117 may have a honeycomb structure or a foamed structure. Like the voids 116 of the previous embodiments, the porosity allows space for expansion and contraction of the midframe 63 without causing buckling of the midframe 63. In one or more embodiments, the material of the midframe 63 or section thereof has a porosity of 20% to 70%. Further, in one or more embodiments, the porous material 117 of the midframe 63 comprises pores 119 having a maximum cross-sectional dimension of at least 0.1 mm, in particular at least 0.5 mm. Further, in one or more embodiments, the pores 119 extend through the entire thickness of the midframe 63, and in one or more other embodiments, the pores 119 only extend partially through the thickness of the midframe 63. Advantageously, the porous material 117 allows for expansion and contraction of the midframe 63 in the longitudinal direction while maintaining the mechanical integrity of the midframe 63 through its thickness.

While each of the foregoing embodiments has been described individually, in one or more embodiments, multiple of the foregoing configurations can be used together to accommodate thermal expansion and contraction of the midframe 63. For example, the midframe 63 can be configured with voids 116 or comprise a porous material and include alignment posts 82, 86 that extend through slots 84, 88 of the fame 64 or ring clips 96 that engage angled posts 92 of the frame 64.

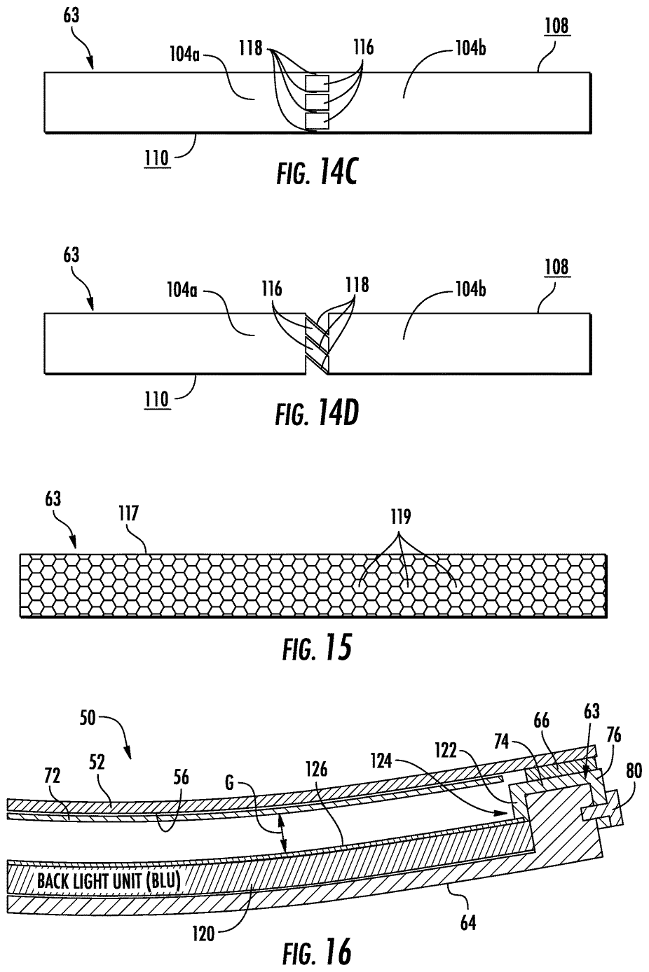

As discussed above, the midframe 63 provides manufacturing advantages in that the midframe 63 can be adhered to the glass substrate 52 in the flat configuration, the midframe 63 and glass substrate 52 can be cold-formed together, and then the midframe 63 can be mechanically attached to the frame 64 during cold-forming without spending significant time on the forming fixture curing. The midframe 63 can also be used to provide additional manufacturing advantages. For example, in one or more embodiments, the midframe 63 can be used to retain thin display films for open cell displays as shown in FIG. 16. In FIG. 16, the glass substrate 52 has a display module 72 mounted to the second major surface 56. A backlight unit 120 is mounted to the frame 64 and a gap G is provided between the backlight unit 120 and the display module 72. As shown in FIG. 16, the midframe 63 includes a third member 122 extending from the first member 74 such that the third member 122 is adjacent an interior surface of the frame 64. In one or more embodiments, including the embodiment depicted, the third member 122 includes a retaining structure 124 configured to hold a film 126 for the backlight unit 120. In one or more embodiments, the film 126 is, for example, a polarizer or light guide designed to improve the efficiency and performance of the display. In such embodiments, the film 126 may be a plastic film having a thickness in a range from about 50 microns to about 300 microns. In one or more embodiments, the retaining structure 124 is a groove formed into the third member 122 into which the film 126 is slid. In this way, the midframe 63 can hold the film 126 in place during assembly of the glass article 50 to ensure proper positioning of the film 126 over the backlight unit 120 in the assembled glass article 50. In one or more embodiments, the film 126 is held between the backlight unit 120 and the display module 72, particularly, in embodiments, in contact with the backlight unit 120.

In one or more other embodiments, the film 126 may be held in place by the third member 122 by positioning the film 126 between the backlight unit 120 and a depending edge of the third member 122. In this way, the film 126 is pinched between the third member 122 and the backlight unit 120 as shown in FIG. 16 when the glass article 50 is assembled. As such, the film 126 is prevented from moving or sliding during the manufacturing process.

As can be seen in the embodiment depicted in FIG. 16, the midframe 63 is joined to the frame 64 using a fastener 80, but in one or more other embodiments, the midframe 63 can be joined to the frame 64 using any of the other mechanical connections described above, such as the alignment posts 82, 86 in slots 84, 88 of the frame 64 or a ring clip 96 of the midframe 63 that engages an angled post 92 of the frame 64.

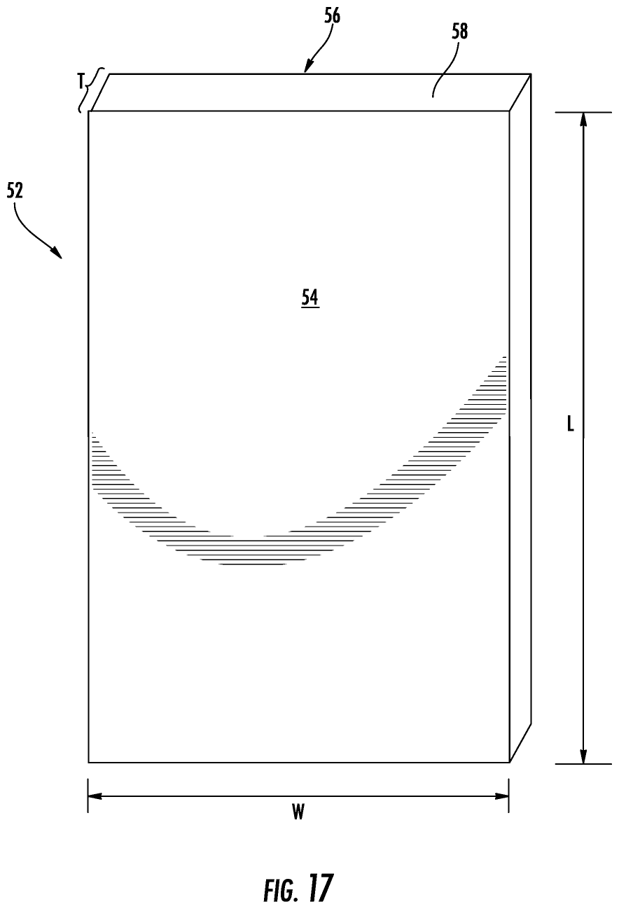

Referring to FIG. 17, additional structural details of glass substrate 52 are shown and described. As noted above, glass substrate 52 has a thickness T that is substantially constant and is defined as a distance between the first major surface 54 and the second major surface 56. In various embodiments, T may refer to an average thickness or a maximum thickness of the glass substrate. In addition, glass substrate 52 includes a width W defined as a first maximum dimension of one of the first or second major surfaces 54, 56 orthogonal to the thickness T, and a length L defined as a second maximum dimension of one of the first or second major surfaces 54, 56 orthogonal to both the thickness and the width. In other embodiments, W and L may be the average width and the average length of glass substrate 52, respectively.

In various embodiments, average or maximum thickness T is in the range of 0.3 mm to 2 mm. In various embodiments, width Wis in a range from 5 cm to 250 cm, and length L is in a range from about 5 cm to about 1500 cm. As mentioned above, the radius of curvature (e.g., R as shown in FIGS. 2A and 2B) of glass substrate 52 is about 30 mm to about 1000 mm.

In embodiments, the glass substrate 52 may be strengthened. In one or more embodiments, glass substrate 52 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass substrate 52 may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In various embodiments, glass substrate 52 may be chemically strengthened by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrate 52 may be immersed in a molten salt bath of 100% NaNO₃, 100% KNO₃, or a combination of NaNO₃ and KNO₃ having a temperature from about 370° C. to about 480° C. In some embodiments, the glass substrate may be immersed in a molten mixed salt bath including from about 5% to about 90% KNO₃ and from about 10% to about 95% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate. The spike may result in a greater surface CS value. This spike can be achieved by a single bath or multiple baths, with the bath(s) having a single composition or mixed composition, due to the unique properties of the glass compositions used in the glass substrates described herein.

In one or more embodiments, where more than one monovalent ion is exchanged into the glass substrate, the different monovalent ions may exchange to different depths within the glass substrate (and generate different magnitudes stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

In one or more embodiments, the glass substrate may be strengthened to exhibit a DOC that is described as a fraction of the thickness T of the glass substrate (as described herein). For example, in one or more embodiments, the DOC may be in the range of about 0.05 T to about 0.25 T. In some instances, the DOC may be in the range of about 20 μm to about 300 μm. In one or more embodiments, the strengthened glass substrate 52 may have a CS (which may be found at the surface or a depth within the glass substrate) of about 200 MPa or greater, about 500 MPa or greater, or about 1050 MPa or greater. In one or more embodiments, the strengthened glass substrate may have a maximum tensile stress or central tension (CT) in the range of about 20 MPa to about 100 MPa.

Suitable glass compositions for use as glass substrate 52 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %. In one or more embodiments, the glass composition includes Al₂O₃ in an amount of about 3 mol % to about 15 mol %. In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass.

In one or more embodiments, the glass composition comprises B₂O₃ in an amount in the range of about 0.01 mol % to about 5 mol %. However, in one or more embodiments, the glass composition is substantially free of B₂O₃. As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ in an amount of about 0.01 mol % to 2 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is in a range from about 8 mol % to about 20 mol %. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount in a range from about from about 8 mol % to about 20 mol %. In one or more embodiments, the glass composition includes K₂O in an amount in a range from about 0 mol % to about 4 mol %. In one or more embodiments, the glass composition may be substantially free of K₂O. In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In one or more embodiments, the glass composition includes CaO in an amount less than about 1 mol %. In one or more embodiments, the glass composition is substantially free of CaO. In some embodiments, the glass composition comprises MgO in an amount from about 0 mol % to about 7 mol %.

In one or more embodiments, the glass composition comprises ZrO₂ in an amount equal to or less than about 0.2 mol %. In one or more embodiments, the glass composition comprises SnO₂ in an amount equal to or less than about 0.2 mol %.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to 1 mol %. Where the glass composition includes TiO₂, TiO₂ may be present in an amount of about 5 mol % or less.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass substrate 52 may be made from any glass composition falling with any one of the exact numerical ranges discussed above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A glass article, comprising:
a glass substrate comprising a first major surface and a second major surface, the second major surface being opposite to the first major surface:
a midframe attached to the second major surface of the glass substrate:
a frame;
wherein the midframe is attached to the frame so that the frame limits thermal dimensional changes of the midframe in a first direction more than thermal dimensional changes of the midframe in a second direction,
wherein the frame comprises longitudinal edges and lateral edges, the longitudinal edges being longer than the lateral edges, wherein the longitudinal edges extend in the second direction and the lateral edges extend in the first direction, wherein the midframe is attached to the frame such that the frame retains the midframe and glass substrate in a curved shape.

2. (canceled)

3. (canceled)

4. The glass article of claim 1, wherein the midframe is attached to glass substrate via an adhesive layer and wherein the midframe is attached to the frame at a plurality of discrete attachment points located at points of maximum adhesive tensile stress, the maximum adhesive tensile stress resulting from a bending stress of the glass substrate and the mid-frame.

5. The glass article of claim 1, wherein the midframe is attached to the frame at a first plurality of discrete attachment points spaced along the lateral edges of the frame.

6. (canceled)

7. The glass article of claim 5, further comprising a second plurality of discrete attachment points between the midframe and frame located on the longitudinal edges of the frame, wherein each longitudinal edge of the frame comprises a half-length (L) extending from a corner where one of the longitudinal edges meets one of the lateral edges to a midpoint of each longitudinal side, and wherein the second plurality of discrete attachment points is located at a distance between 0.075 L to 0.15 L from each corner.

8. The glass article of claim 7, wherein the first plurality of discrete attachment points, the second plurality of discrete attachment points, or both the first plurality of discrete attachment points and the second plurality of discrete attachment points comprise slots formed in the frame and posts extending from the midframe through the slots.

9. The glass article of claim 1, wherein the frame comprises a plurality of alignment slots and wherein the midframe comprises a plurality of alignment posts configured to engage the plurality of alignment slots.

10. The glass article of claim 9, wherein the plurality of alignment slots comprises first alignment slots on the lateral edges, the first alignment slots comprise a first width and a first length perpendicular to the first width and parallel to the lateral edges, wherein the plurality of alignment posts comprise first alignment posts corresponding to the first alignment slots of the lateral edges, wherein the first alignment posts comprise a second width and a second length perpendicular to the second width and parallel to the lateral edges, wherein the second length is substantially equal to the first length, and wherein the second width is less than the first width.

11. The glass article of claim 10, wherein the second width is up to 4 mm less than the first width.

12. The glass article of claim 10, wherein the plurality of alignment slots further comprises a second alignment slot on a longitudinal edge, wherein the second alignment slot comprises a third width parallel to the longitudinal edge and a third length perpendicular to the third width, wherein the plurality of alignment posts comprises a second alignment post corresponding to the second alignment slot, wherein the second alignment post comprises a fourth width parallel to the longitudinal edge and a fourth length perpendicular to the fourth width, and wherein the fourth width is substantially equal to the third width.

13. The glass article of claim 12, wherein the fourth length is substantially equal to the third length.

14. The glass article of claim 12, wherein the fourth length is up to 4 mm less than the third length.

15. (canceled)

16. The glass article of claim 1, wherein the frame comprises a support surface disposed on the midframe and an exterior edge substantially perpendicular to the support surface, wherein the midframe and the frame are attached by a plurality of clips, wherein the plurality of clips comprises:
a plurality of angled posts each extending at an acute angle from the exterior edge such that each of the plurality of angled posts forms a recess with the exterior edge of the frame, and
a corresponding plurality of ring clips formed on the midframe, each ring clip of the corresponding plurality of ring clips configured to engage the recess of each of the plurality of angled posts upon thermal expansion of the midframe.

17. The glass article of claim 16, wherein each of the corresponding plurality of ring clips comprises a ring opening having a first width, wherein each of the plurality of angled posts has a second width, and wherein the first width is greater than the second width.

18. The glass article of claim 1, wherein the midframe comprises a perimeter, wherein the midframe comprises a plurality of expansion joints formed in the perimeter, and wherein each expansion joint comprises a first section of the midframe disconnected from a second section of the midframe, wherein the first section and the second section comprise complementary endfaces.

19. (canceled)

20. (canceled)

21. The glass article of claim 1, wherein the midframe comprises a plurality of regions having at least one void formed through a thickness of the midframe.

22. (canceled)

23. The glass article of claim 1, wherein the midframe comprises a porous material comprising a porosity of 20% to 70%.

24. (canceled)

25. The glass article of claim 23, wherein the porous material comprises pores having a maximum cross-sectional dimension of at least 0.1 mm.

26. A glass article, comprising:
a glass substrate comprising a first major surface and a second major surface, the second major surface being opposite to the first major surface;
a midframe attached to the second major surface of the glass substrate;
a frame;
wherein the midframe is attached to the frame by either a plurality of discrete attachment points or in a manner that allows for relative movement between the midframe and the frame responsive to thermal expansion or contraction of the midframe.

27. (canceled)

28. The glass article of claim 26, wherein the midframe is attached to the frame by the plurality of discrete attachment points, wherein the frame comprises longitudinal edges and lateral edges, the longitudinal edges being longer than the lateral edges, and wherein the plurality of discrete attachment points comprise first discrete attachment points spaced along the lateral edges of the frame, wherein the plurality of discrete attachment points comprises second discrete attachment points between the midframe and frame located on the longitudinal edges of the frame, wherein each longitudinal edge of the frame comprises a half-length (L) extending from a corner where one of the longitudinal edges meets one of the lateral edges, and wherein the second discrete attachment points is located at a distance between 0.075 L to 0.15 L from each corner.

29. (canceled)

30. (canceled)

31. The glass article of claim 26, wherein the midframe is attached to the frame in the manner that allows for relative movement between the midframe and the frame responsive to thermal expansion or contraction of the midframe, wherein the frame comprises a plurality of alignment slots and wherein the midframe comprises a plurality of alignment posts configured to engage the plurality of alignment slots, wherein the frame comprises longitudinal edges and lateral edges, the longitudinal edges being longer than the lateral edges, wherein the plurality of alignment slots comprises first alignment slots on the lateral edges, the first alignment slots comprise a first width and a first length perpendicular to the first width and parallel to the lateral edges, wherein the plurality of alignment posts comprise first alignment posts corresponding to the first alignment slots of the lateral edges, wherein the first alignment posts comprise a second width and a second length perpendicular to the second width and parallel to the lateral edges, wherein the second length is substantially equal to the first length, wherein the second width is up to 4 mm less than the first width.

32. (canceled)

33. (canceled)

34. (canceled)

35. (canceled)

36. (canceled)

37. (canceled)

38. (canceled)

39. (canceled)

40. (canceled)

41. (canceled)
